(19) United States
(12) Patent Application Publication
(10) Pub. No.: US 2005/0256599 A1
(43) Pub. Date: Nov. 17, 2005

(54) SYSTEM AND METHOD THEREOF FOR REAL-TIME BATCH DISPATCHING MANUFACTURING PROCESS

(76) Inventor: Chin-Lang Peng, Hsin-Chu Hsien (TW)

Correspondence Address: NORTH AMERICA INTELLECTUAL PROPERTY CORPORATION, P.O. BOX 506, MERRIFIELD, VA, 22116, US

(21) Appl. No.: 10/904,653

(22) Filed: Nov. 22, 2004

(30) Foreign Application Priority Data
May 12, 2004 (TW) 093113319

(51) Int. Cl. G06F 19/00

(52) U.S. Cl. 700/100; 700/103

(57) ABSTRACT

The present invention provides a system and method for real-time batch dispatching in a manufacturing process. The system includes a bottleneck equipment, a real-time dispatching module for calculating a time point of forming a batch and deciding the lot numbers of a plurality of products which are included in the batch at the time point, and a manufacturing execution system electronically connected to the bottleneck equipment and the real-time dispatching module for receiving the batch transmitted from the real-time dispatching module so as to choose the plurality of products according to the lot numbers and controlling the plurality of products to be simultaneously processed by the bottleneck equipment at the same time point.

### BACKGROUND OF INVENTION

1. Field of the Invention

The invention relates to a system and a method thereof for batch dispatching in a manufacturing process, and more particularly, to a system and a method thereof for real-time batch dispatching in a manufacturing process.

2. Description of the Prior Art

In a manufacturing process of a product, many types of equipment are required to execute the manufacturing process. Because the execution time of each piece of equipment is different, a product cannot enter into the next equipment to undergo another procedure of the process until the next equipment is available. Therefore, there is a bottleneck in the process due to the equipment that has the longest execution time for executing a corresponding procedure of the process. For example, in a semiconductor process, semiconductor products are produced by using many equipment types to process a wafer. The wafer is processed by a plurality of equipment types, and finally enters the furnace to undergo thermal oxidation. Because the execution time of the furnace to perform the thermal oxidation is longer than the execution time of any other equipment, the procedure of the furnace is a bottleneck of the process of the wafer. Therefore, a dispatch system is used to control the delivery of the wafers that enhances the whole efficiency of process.

Please refer to FIG. 1. FIG. 1 is a schematic diagram of a manufacturing dispatching system 10 according to the prior art. The manufacturing dispatching system 10 includes a manufacturing execution system (MES) 14, an automatic material handling system (AMHS) 16, a terminal control system (TCS) 18, a plurality of equipment 20, and a furnace 22. The wafers are processed from each equipment 20 to the furnace 22 in sequence. The execution time of the furnace 22 is longer than the execution time of any other equipment 20, so the furnace 22 is a bottleneck during the process of the wafer. The MES 14 controls the equipment 20 and the furnace 22. The AMHS 16 communicates with the MES 14, the equipment 20, and the furnace 22 to receive orders from the MES 14 to move the wafer in and out of the equipment 20 and the furnace 22. The TCS 18 communicates with the MES 14, the equipment 20, and the furnace 22 to receive orders from the MES 14 to control the equipment 20 and the furnace 22 to process the wafers.

Additionally, when the furnace 22 finishes the thermal oxidation of the wafers, the furnace 22 transmits a finished signal to the MES 14 to announce to the MES 14 that the furnace 22 is standing by and can accept a dispatch. When the MES 14 gets the standby announcement of the furnace 22, the MES 14 controls each equipment 20 and the furnace 22 in sequence to execute another batch wafer process via the AMHS 16 and the TCS 18.

However, the MES 14 will not control the equipment 20 and the furnace 22 to execute other batch wafer processes unless the standby announcement of the furnace 22 is received. When the MES 14 generates orders to control the equipment 20 and the furnace 22, the MES 14 does not consider the required execution time of the various pieces of equipment 20 and the furnace 22. Therefore, the quality-time management of the equipment 20 and the furnace 22 cannot be optimized, and the efficiency of the manufacturing dispatching system 10 during semiconductor process is difficult to improve.

### SUMMARY OF INVENTION

It is therefore a primary objective of the claimed invention to provide a system and method for real-time batch dispatching in a manufacturing process to solve the above-mentioned problem.

According to the claimed invention, a system for real-time batch dispatching in a manufacturing process includes a bottleneck equipment, a real-time dispatching module for calculating a time point of forming a batch and deciding lot numbers of a plurality of products which are included in the batch at the time point, and a MES electronically connected to the bottleneck equipment and the real-time dispatching module for receiving the batch transmitted from the real-time dispatching module so as to choose plurality of products according to the lots numbers and control the plurality of products to be simultaneously processed by the bottleneck equipment at the same time.

The present invention further provides a method for real-time batch dispatching in a manufacturing process including calculating a time point to form the batch and deciding the lot numbers of products at the time point, receiving the batch to choose the corresponding products, and controlling the products entering the bottleneck equipment to be processed at the same time.

The present invention can detect in real-time the state of the equipment and the furnace to produce the batch, control the moving and processing of the wafers in the equipment and the furnace, decrease the standby time and enhance the utilization of the equipment and the furnace, and enhance the efficiency of the system for dispatching in a manufacturing process. In addition, the method of the present invention is useful for any process having a bottleneck procedure, such as a process of manufacturing a liquid crystal display (LCD).

These and other objectives of the present invention will no doubt become obvious to those of ordinary skill in the art after reading the following detailed description of the preferred embodiment is illustrated figures and drawings.

### BRIEF DESCRIPTION OF DRAWINGS

FIG. 1 is a schematic diagram of a system for dispatching in a manufacturing process according to the prior art.

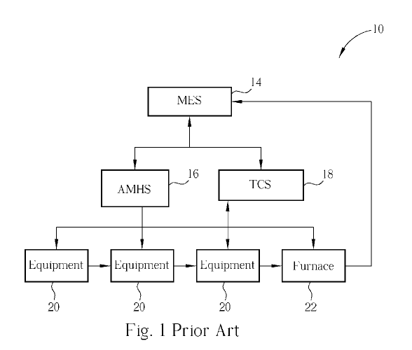

FIG. 2 is a schematic diagram of a system for batch dispatching in a manufacturing process according to the present invention.

FIG. 3 is a flow chart of the system shown in FIG. 2.

### DETAILED DESCRIPTION

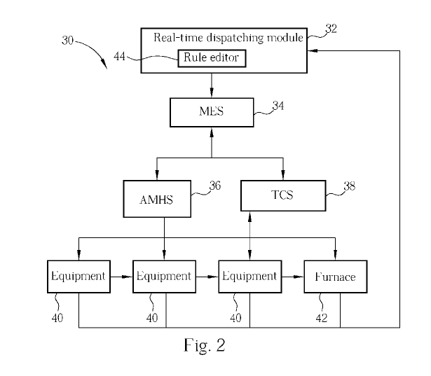

Please refer to FIG. 2. FIG. 2 is a schematic diagram of a system 30 for dispatching batches in a manufacturing process according to the present invention. The system 30 includes a real-time dispatching module 32, a MES 34, a AMHS 36, a TCS 38, a plurality of equipment 40, and a furnace 42. The wafers are processed from the equipment 40 and the furnace 42 in sequence. Each of the pieces of equipment 40 performs a specific procedure to perform on the wafers, and the furnace 42 is used to perform thermal oxidation of the wafers. The execution time of the furnace 42 to perform the thermal oxidation is usually longer than the execution time of one of the pieces of equipment 40 to perform the specific procedure, so the furnace 42 is a bottleneck during the process of the wafers. To optimize the efficiency of the equipment 40 and the furnace 42, the whole process of wafers must use a method of quality-time control to control the equipment 40 and the furnace 42.

The real-time dispatching module 32 communicates with the MES 34 to form a batch according to the state of the equipment 40 and the furnace 42 to control and manage the dispatching of the equipment 40 and the furnace 42. The real-time dispatching module 32 utilizes a rule editor 44 to edit at least a dispatching rule, and calculates a time point to form the batch according to the dispatching rule. The real-time dispatching module 32 produces the batch including the lot numbers of a plurality of products at the time point wherein the real-time dispatching rule is accordance with real-time module 30 such as the execution time of the procedures for the manufacturing process, the time intervals between the procedures of the manufacturing process, the product types, the status of the equipment, the materials used to perform the procedures, and the management plans of the factory to define the optimum rule. The real-time dispatch module 32 produces the batch and transmits the batch to the MES 34 to start the process flow of the products in the batch.

The MES 34 saves the batch to control the movement and processing of the wafers in the equipment 40 and the furnace 42. The AMHS 36 connected the MES 34, the equipment 40, and the furnace 42, is controlled by the MES 34 to move the wafers in and out of the equipment 40 and the furnace 42.

According to the present invention, the system for real-time batch dispatching in a manufacturing process will elect the most appropriate wafers to proceed with batch dispatching in order to obtain maximum efficiency of each equipment 40 and the furnace 42. When the MES 34 receives the batch that is produced by the real-time dispatching module 32, the MES 34 orders the AMHS 36 to move wafers according to the batch and orders the TCS 38 to control each equipment 40 and the furnace 42 to process the wafers. When the MES 34 controls the AMHS 36 and the TCS 38, the MES 34 transmits a moving requirement signal to the AMHS 36 according to the batch, and makes the AMHS 36 move the wafers in or out of the equipment 40 or of the furnace 42 according to the requirement signal, and the AHMS 36 returns a moving confirmation signal to the MES 34 after moving the wafers. Next, the MES 34 transmits a processing requirement signal to the TCS 38 according to the batch, and the TCS 38 controls the equipment 40 and the furnace 42 to process the wafers according to the processing requirement signal. The TCS 38 finishes controlling the equipment 40 and the furnace 42 and returns a processing confirmation signal to the MES 34. In addition, when each equipment 40 or the furnace 42 finishes processing, the MES 34 returns a processing confirmation signal to the real-time dispatching module 32, and the real-time dispatching module 32 obtains the locating state of the equipment 40 and the furnace 42 in real-time. On the other hand, each of the equipment 40 can be wet-etching or washing equipment, and relies on liquid to wet-etch or wash the wafers.

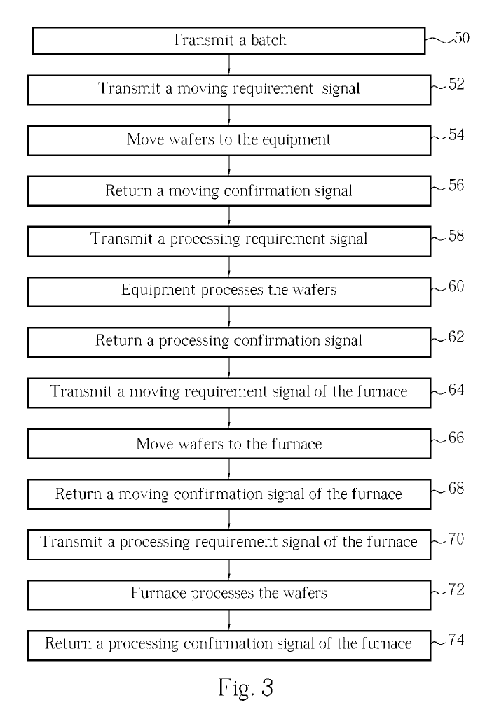

Please refer to FIG. 3 and FIG. 2. FIG. 3 is a flow chart of the system 30 shown in FIG. 2, which includes the following steps:
Step 50: The real-time module 32 decides the content of the batch according to the dispatching rule, and transmits the batch to the MES 34;
Step 52: The MES 34 transmits a moving requirement signal to the AMHS 36 according the batch;
Step 54: The AMHS 36 selects and moves the corresponding wafers according to the moving requirement signal;
Step 56: The AMHS 36 returns the moving confirmation signal to the MES 34 after moving the wafers;
Step 58: The MES 34 transmits a processing requirement signal to the TCS 38 according to the batch, and the TCS 38 controls the process wafer of the equipment 40 according to the processing requirement signal;
Step 60: The equipment 40 processes the wafers;
Step 62: The equipment 40 returns a processing confirmation signal to the TCS 38 after processing the wafers, and the TCS 38 returns a processing confirmation signal to the MES 34;
Step 64: The MES 34 transmits a moving requirement signal of the furnace 42 to the AMHS 36 according to the batch;
Step 66: The AMHS 36 moves the selected wafers to the furnace 42 according to the moving requirement signal of the furnace 42;
Step 68: The AMHS 36 returns a moving confirmation signal of the furnace 42 to the MES 34 after moving the wafers;
Step 70: The MES 34 transmits a processing requirement signal of the furnace 42 to the TCS 38 according to the batch, and the TCS 38 controls the furnace 42 to process the wafers according to the processing requirement signal of the furnace 42;
Step 72: The furnace 42 performs thermal oxidation on selected wafers; and
Step 74: The furnace 42 returns a processing confirmation signal of the furnace 42 to the TCS 38 after thermal oxidation, and the TCS 38 returns a processing confirmation signal of the furnace 42 to the MES 34.

In contrast to the prior art, the present invention system and method for real-time batch dispatching in semiconductor furnace manufacturing processes can produce the batch in real-time according to a dispatching rule, and makes the MES control the movement and processing of the wafers in the equipment and the furnace according to the batch for decreasing the unused time of the equipment and the furnace and for increasing efficiency. In addition, the above-mentioned dispatching rule enables each equipment and the furnace to obtain maximum efficiency according to the time required for the manufacturing process, the interval time between execution of the manufacturing process, product types, the status of the equipment, the material of the manufacturing process, and the plan of the factory management. On the other hand, any process that contains a bottleneck, such as the liquid crystal display (LCD) or semiconductor process, can use the present invention method according to a dispatching rule to produce the corresponding dispatching file in real-time, and to dispatch the process of producing the products for enhancing the efficiency of the whole manufacturing process

Those skilled in the art will readily observe that numerous modifications and alterations of the device may be made while retaining the teachings in the invention. Accordingly, the above disclosure should be construed as limited only by the metes and bounds of the appended claims.

1. A system for real-time dispatching a batch in a manufacturing process comprising:
a bottleneck equipment;
a real-time dispatching module for calculating a time point to form the batch and deciding lot numbers of a plurality of products which are included in the batch at the time point; and
a manufacturing execution system (MES) electronically connected to the bottleneck equipment and the real-time dispatching module for receiving the batch from the real-time dispatching module so as to choose the plurality of products according to the lot numbers and control the plurality of products to be simultaneously processed by the bottleneck equipment at the same time.

2. The system of claim 1 wherein the real-time dispatching module calculates the time point and decides content of the batch according to a dispatching rule, and the dispatching rule is built according to execution time of procedures of the manufacturing process, time intervals between the procedures, product types, a status of the equipment, materials used to perform the procedures, and management plans of a factory.

3. The system of claim 2 wherein the real time dispatching module includes a rule editor for editing the dispatching rule.

4. The system of claim 1 further comprising:
an automatic material handling system (AMHS), electronically connected to the MES and the bottleneck equipment, wherein the MES controls the AMHS to move the products in and out of the bottleneck equipment; and
a tool control system (TCS), electronically connected to the MES and the bottleneck equipment, wherein the MES controls the TCS to control the bottleneck equipment to process the plurality of products.

5. The system of claim 4 further comprising:
a plurality of equipment electronically connected to the AMHS, the MES controlling the AMHS to move the products in and out of the plurality of equipment, and the MES controlling the TCS to control the equipment to process the products.

6. The system of claim 5 wherein the bottleneck equipment is a furnace, and the plurality of products are a plurality of wafers.

7. The system of claim 6 wherein the MES transmits a moving requirement signal to the AMHS according to the batch, the AMHS moves a selected wafer into one of the plurality of equipment according to the moving requirement signal, and the AMHS returns a moving confirmation signal to the MES after moving the selected wafer.

8. The system of claim 6 wherein the MES transmits a processing requirement signal to the TCS according to the batch, and the TCS controls one of the plurality equipment to process the wafer according to the processing requirement signal and returns a processing confirmation signal to the MES after processing the wafer.

9. The system of claim 6 wherein the MES transmits a moving requirement signal of the furnace to the AMHS according to the batch, and the AMHS moves an elected wafer into the furnace according to the moving requirement signal of the furnace and returns a moving confirmation signal of the furnace to the MES after finishing moving.

10. The system of claim 6 wherein the MES transmits a processing requirement signal of the furnace to the TCS according to the batch, and the TCS controls an elected wafer to undergo thermal oxidation in the furnace according to the processing requirement signal of the furnace and returns a processing confirmation signal of the furnace to the MES after finishing thermal oxidation.

11. A method for real-time batch dispatching in a manufacturing process, comprising:
calculating a time point of forming a batch and deciding lot numbers of a plurality of products at the time point; and
receiving the batch to choose the corresponding products to be included in the batch and controlling the products entering a bottleneck equipment to be processed at the same time point.

12. The method of claim 11 further comprising:
making a dispatch rule, and forming wherein the batch is formed according to the dispatch rule and in-line product status of the bottleneck equipment.

13. The method of claim 12 wherein the dispatch rule is made according to execution time of procedures of the manufacturing process, time intervals between the procedures, product types, a status of the equipment, materials used to perform the procedures, and management plans of a factory.

14. The method of claim 111 further comprising:
controlling a AMHS to move the products in and out of the bottleneck equipment; and
controlling a TCS to control the bottleneck equipment to process the products

15. The method of claim 14 further comprising:
controlling the AMHS to move the products in and out of a plurality of equipment; and
controlling the TCS to control the plurality of equipment to process the products.

16. The method of claim 15 wherein the bottleneck equipment is a furnace, and the products are a plurality of wafers.

17. The method of claim 16 further comprising transmitting a moving requirement signal to the AMHS according to the batch for moving elected wafers into the equipment, and returning a moving confirmation signal of the equipment by the AMHS to the batch after moving the elected wafers.

18. The method of claim 16 further comprising transmitting a processing requirement signal to the TCS according to the batch for controlling the equipment to process the wafer, and returning a processing confirmation signal by the TCS to the batch after finishing processing.

19. The method of claim 16 further comprising transmitting a moving requirement signal of the furnace to the AMHS according to the batch for moving the elected wafers into the furnace, and returning a moving confirmation signal of the furnace by the AMHS to the batch after moving the elected wafer.

20. The method of claim 16 further comprising transmitting a processing requirement signal of the furnace to the TCS according to the batch for controlling the elective wafer to undergo thermal oxidation in the furnace, and returning a processing confirmation signal of the furnace by the TCS to the MES after thermal oxidation.
